(19) United States
(12) Patent Application Publication
(10) Pub. No.: US 2026/0073331 A1
(43) Pub. Date: Mar. 12, 2026

(54) Computing System and Method for Automatically Generating Construction Activity Logs

(71) Applicant: Procore Technologies, Inc., Carpinteria, CA (US)

(72) Inventors: Farid Mirahadi, North York (CA); Matt Man, Thornhill (CA); Mohammad Mostafa Soltani, Toronto (CA)

(21) Appl. No.: 18/826,741

(22) Filed: Sep. 6, 2024

(51) Int. Cl. G06Q 10/0633; G06Q 50/08

(52) U.S. Cl. CPC G06Q 10/0633; G06Q 50/08

(57) ABSTRACT

A computing system is configured to: (i) generating a first prompt for input to a generative AI model, wherein the first prompt comprises input data and a request to determine a type of log to be generated, (ii) inputting the first prompt to the generative AI model, causing the model to output an indication of a type of log to be generated, (iii) based on the indication, obtaining a template for the type of log to be generated, (iv) generating a second prompt for input to a generative AI model, wherein the second prompt comprises the template for the type of log to be generated, the input data, and a request to generate a construction activity log of the indicated type, and (v) inputting the second prompt to the generative AI model thereby causing the generative AI model to generate a construction activity log of the indicated type.

### BACKGROUND

Increasingly, parties involved in construction projects are beginning to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may include specifications, drawings, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### SUMMARY

Disclosed herein is new technology for automatically generating construction activity logs based on construction project data and a set of templates for construction activity logs.

In one aspect, the disclosed technology may take the form of a method to be carried out by a computing platform that involves (i) generating a first prompt for input to one or more generative AI models, wherein the first prompt comprises construction-based input data and a request to determine a type of construction activity log to be generated, (ii) inputting the first prompt to the one or more generative AI models thereby causing the one or more generative AI models to output an indication of a type of construction activity log to be generated, (iii) based on the indication of the type of construction activity log to be generated, obtaining a template for the type of construction activity log to be generated, (iv) generating a second prompt for input to the one or more generative AI models, wherein the second prompt comprises the template for the type of construction activity log to be generated, the construction-based input data, and a request to generate a construction activity log of the indicated type, (v) inputting the second prompt to the one or more generative AI model thereby causing the one or more generative AI models to generate a construction activity log of the indicated type, and (vi) causing a client device associated with a user to present a representation of the generated construction activity log.

The one or more generative AI models may take various forms. In some examples, the one or more generative AI models comprise a single generative AI model. In some other examples, the one or more generative AI models comprise a first generative AI model and a second generative AI model. In such examples, inputting the first prompt to the one or more generative AI models may involve inputting the first prompt to the first generative AI model thereby causing the first generative AI model to output the indication of the type of construction activity log to be generated. In such examples, inputting the second prompt to the one or more generative AI models may involve inputting the second prompt to the second generative AI model thereby causing the second generative AI model to generate the construction activity log of the indicated type. In some further examples, the second generative AI model is one of a set of type-based generative AI models, each corresponding to a respective type of construction activity log. In such examples, the method to be carried out by the computing platform involves (i) determining that the indication of the type of construction activity log to be generated matches the type of construction activity log corresponding to the second generative AI model and (ii) based on determining that the indication of the type of construction activity log to be generated matches the type of construction activity log corresponding to the second generative AI model, selecting the second generative AI model from the set of type-based generative AI models.

In some examples, the one or more generative AI models may take the form of at least one transformer-based generative AI model. The at least one transformer-based generative AI model may take various forms and, in some examples, the at least one transformer-based generative AI model may take the form of a large language model (LLM).

The template for the type of construction activity log take various forms and, in some examples, the template for the type of construction activity log may include a plurality of input fields. In such examples, causing the one or more generative AI models to generate a construction activity log of the indicated type involves causing the one or more generative AI models to (i) generate a construction activity log comprising the plurality of input fields and (ii) automatically populate the plurality of input fields with construction activity summary data.

The construction-based input data may take various forms. In some examples, the construction-based input data may include one or more of image data or video data.

In another example, the method to be carried out by a computing platform may further involve (i) after causing the client device associated with the user to present the representation of the generated construction activity log, receive data indicating one or more interactions of the user with the generated construction activity log, (ii) inputting the data indicating the interactions of the user with the generated construction activity log to a reinforcement model thereby causing the reinforcement model to generate a score value based for the generated construction activity log, and (iii) retraining the one or more generative AI models based on the score value.

In yet another aspect, disclosed herein is a computing platform that includes at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing methods.

In yet another aspect, disclosed herein is a non-transitory computer-readable medium having stored thereon program instructions that that are executable to cause a computing platform to carry out the functions disclosed herein, including but not limited to the functions of the foregoing methods.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1 depicts an example network environment in which a construction management software application may be implemented, according to the present disclosure.

FIG. 2A depicts a first graphic user interface (GUI) view of a software tool that provides an input interface for inputting construction activity data, according to the present disclosure.

FIG. 2B depicts a second graphic user interface (GUI) view of the software tool of FIG. 2A that provides an input interface inputting construction activity data in a specific category, according to the present disclosure.

FIG. 2C depicts a continuation of the second graphic user interface (GUI) view of FIG. 2B, according to the present disclosure.

FIG. 3 depicts a first illustrative example of a computing architecture that may be utilized to automatically generate a construction activity log, according to the present disclosure.

FIG. 4 is a flowchart for one possible implementation of functionality for automatically generating a construction activity log, in accordance with the present disclosure.

FIG. 5 depicts a second illustrative example of a computing architecture that may be utilized to automatically generate a construction activity log, according to the present disclosure.

FIG. 6 is a flowchart for another possible implementation of functionality for automatically generating a construction activity log, in accordance with the present disclosure.

FIG. 7 depicts a GUI view of an illustrative example of a construction activity log as generated by the computing systems and methods disclosed herein.

FIG. 8 is a simplified block diagram illustrating some structural components that may be included in an example computing platform that may be configured to perform some or all of the server-side functions disclosed herein.

FIG. 9 is a simplified block diagram illustrating some structural components that may be included in an example client device that may be configured to perform some or all of the client-side functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several examples. A person of ordinary skill in the art should understand that such references are for the purpose of explanation only and are therefore not meant to be limiting. Part or all of the disclosed platforms, devices, and methods may be rearranged, combined, added to, and/or removed in a variety of manners, each of which is contemplated herein.

Construction management today is often performed through the use of software applications, such as the software application provided by Procore Technologies, Inc.® (“Procore”), the applicant of the present disclosure. These construction management software applications generally provide users the ability to create, store, view, and/or interact with various types of data related to a construction project, such as schedules, daily logs, images, drawings, specifications, building information models (BIMs), sensor data, budgets, change orders, communications, invoices, directories, punch lists, timesheets, requests for information (RFIs), submittals, and/or reports, among other types of data.

In practice, these construction management software applications may take various forms. As one possible implementation, a construction management software application may include both front-end client software running on client devices that are accessible to individuals associated with construction projects (e.g., contractors, project managers, architects, engineers, designers, etc.) and back-end software running on a back-end platform (sometimes referred to as a “cloud” platform) that interacts with and/or drives the front-end software, and which may be operated (either directly or indirectly) by the provider of the front-end client software. As another possible implementation, a construction management software application may include front-end client software that runs on client devices without interaction with a back-end platform. These software applications may take other forms as well.

In general, such front-end client software may provide parties involved in a construction project with tools for performing and managing various tasks related to the construction project. Further, such front-end client software may take various forms, examples of which may include a native application (e.g., a mobile application) and/or a web application running on a client device, among other possibilities.

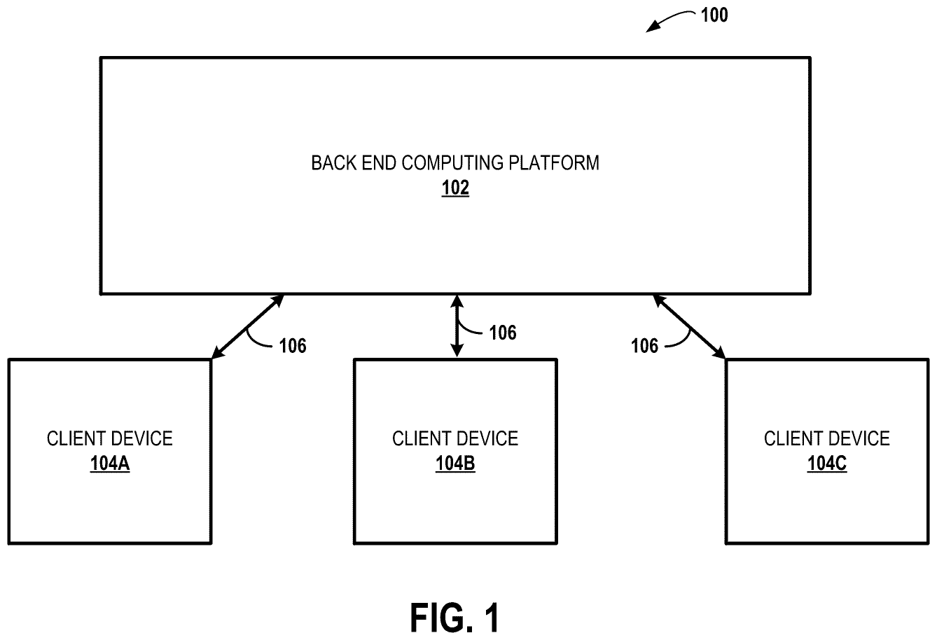

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which as shown includes the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of back-end computing platform 102 may collectively comprise some set of physical computing resources (e.g., one or more processors, data storage system, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106. In this respect, each communication path 106 between the back-end computing platform 102 and one of the client devices 104 may generally comprise one or more communication networks and/or communications links, which may take any of various forms. For instance, each respective communication path 106 with the back-end computing platform 102 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each respective communication path 106 with the back-end computing platform 102 may be wireless, wired, or some combination thereof, and may carry data according to any of various different communication protocols. Further yet, communications over each respective communication path 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). Many other environments are also possible.

Although not shown in FIG. 1, the back-end computing platform 102 may also be configured to receive data, such as data related to a construction project, from one or more external data sources, such as an external database and/or another back-end computing platform or platforms. Such data sources—and the data output by such data sources—may take various forms.

It should be understood that the network environment 100 depicted in FIG. 1 is one example of a network environment in a construction management software application may be implemented. Numerous other arrangements are possible and contemplated herein. For instance, other network configurations may include additional components not pictured and/or more or fewer of the pictured components.

In line with the discussion above, existing construction management software applications may enable users to electronically manage construction projects, which may involve software features for creating, storing, viewing, and/or interacting with various types of data objects that memorialize information related to the construction project. These data objects could take various forms, examples of which may include RFI data objects, Daily Log data objects, Invoice data objects, and/or Timesheet data objects, among various other examples. Further, in at least some implementations, the software features for creating, storing, viewing, and/or interacting with the various types of data objects may optionally be arranged into different software “tools” that each correspond to a different type (or category) of data object. For instance, a construction management software application may include an “RFIs” tool for creating, storing, viewing, and/or interacting with RFI data objects, a “Daily Log” tool for creating, storing, viewing, and/or interacting with Daily Log data objects, and so on. However, in other implementations, the software features for creating, storing, viewing, and/or interacting with the various types of data objects may be arranged in other manners that are not based on software tools paradigm.

In operation, existing construction management software applications may enable a representative of a given party (e.g., a general contractor) to (i) create an account with a construction management software application and (ii) add a set of individuals associated with the given party as users on the given party's account. After the given party's account is created and a set of users have been added, the construction management software application may thereafter enable the representative of the given party (or some other representative that has been added to the account as a user having the requisite permissions) to (i) create a respective project workspace for each of one or more construction projects that involve the given party and (ii) for each such construction project, designate a respective subset of the given party's users that are allowed to access data associated with the respective project workspace. In this respect, the given party may be considered to be the “owner” of the project workspace(s) and the data contained therein.

Such data gathered via construction management software applications (and/or software tools thereof) and contained therein may be utilized in documenting construction projects via the use of construction activity logs. A construction activity log may be a data object that documents one or more aspects of a given construction project at a given point in time during construction. Construction activity logs may take numerous forms, depending on the type of data being logged, some examples of which will be discussed below. In many cases, construction activity logs document construction progress and other conditions related to a given construction project such as material delivery status, construction task status (e.g., installation status), observations related to the construction site, documentation of completed tasks, inspection results, among various other possibilities. To that end, a construction activity log may include, for example, any data that serves to document what construction task was performed and by whom, when said construction task was performed, where the task occurred, why conditions associated with the construction task occurred, how well the construction task was performed, among other things. Further, construction activity logs may comprise other forms of data that document a construction project over a given timeframe (e.g., daily construction activity logs, phase-based construction activity logs, periodic construction progress reports, etc.).

In some examples, a construction management software application (and/or a software tool thereof) may gather input data for construction activity logs via any number of sources. Such input data may take the form of sensor data that is captured by one or more sensors (e.g., a camera, a microphone, etc.) of a client device, such as the example client devices 104 shown in FIG. 1. Further, the input data may take the form of data received from a user of the client device (e.g., text data, speech data, etc.). Additionally or alternatively, some input data may include previously recorded data from a back-end computing platform 102. Further still, any of these forms of input data (and others) may include markups (e.g., user markings overlain on data, annotations, highlights, etc.) as part of the input data or as another data object associated with the input data to be marked up. Data inputs for construction management software applications may take various other forms, as well.

In some examples, input data may be presented to a user of the construction management software application via one or more input interfaces within the construction management software application (or a software tool thereof). These input interfaces may be presented to a user, by a client device 104 executing the construction management software application, via software features of the construction management software application (or a software tool thereof) that are configured for creating, reviewing, and/or managing a variety of forms of construction activity logs.

These input interfaces may be presented having a plurality of sub-categories of input fields for use in generating, updating, and/or managing construction activity logs. For example, a tool for generating construction activity logs may provide one or more interfaces for manually inputting timeline data (e.g., dates of completion, timeframe for a given construction activity log, etc.), interfaces for manually inputting quantitative construction data (e.g., materials on hand, percentage of material installed, labor hours within a given timeframe, etc.), interfaces for inputting qualitative construction data (e.g., documentation of an inspection, evaluations of quality of an ongoing task, etc.), and/or interfaces for inputting audio/visual content associated with a construction project (e.g., photos associated with a construction project, videos associated with a construction project, audio recordings associated with a construction project), among other things.

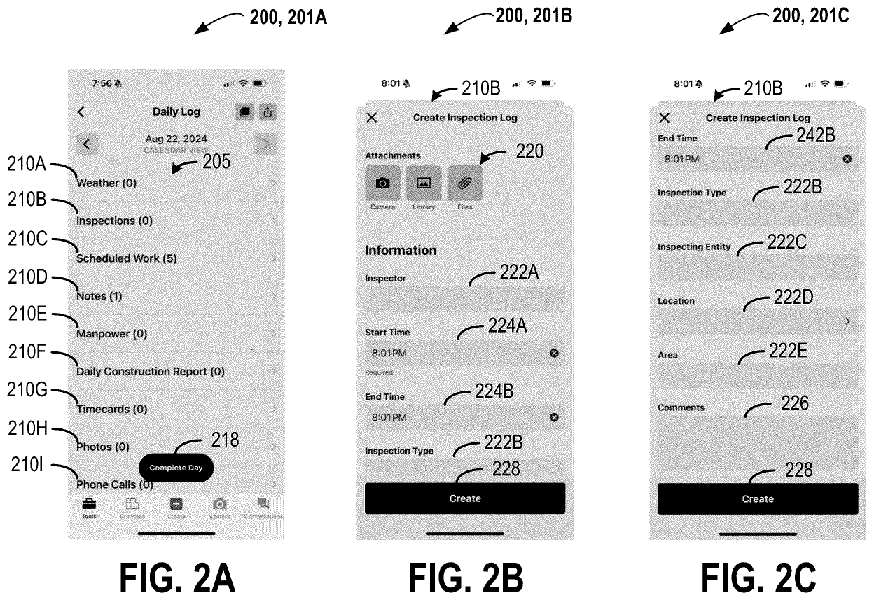

To further illustrate how construction activity logs may be generated and may benefit a user of a construction management software application, FIGS. 2A-2C and the associated description are provided. One example of a software tool 200 that may be utilized in generating a construction activity log is illustrated via the example graphic user interface (GUI) views of FIGS. 2A-2C. The software tool 200, as illustrated, may be a software tool that is configured to document construction activity logs within a daily timeframe (e.g., the “Daily Logs” software tool of the construction management software application provided by Procore Technologies, Inc.); however, it is certainly contemplated that the software tool 200 can log construction activity over a different timeframe and is not limited to daily logging of construction activity. This tool may be utilized by a user, via a client device 104 executing the software tool 200, to generate construction activity logs based on a variety input data and/or previously stored data.

As mentioned above, construction activity logs may be compiled based on input from a wide variety of different data sources and, as illustrated in the first GUI view 201A of FIG. 2A, the software tool 200 may present a user of a client device 104 with a plurality of categorical input interfaces 210 that are configured to guide the user of the client device 104 to input specific forms of data therein, for use by the software tool 200 in compiling a construction activity log. Such categorical input interfaces 210, as illustrated, may include a weather input interface 210A (e.g., for documenting weather conditions at a site of a construction project), an inspections input interface 210B (e.g., for documenting data associated with an inspection of a construction project), a scheduled work input interface 210C (e.g., for monitoring and/or recording scheduled work within the selected timeframe for a construction project), a notes input interface 210D (e.g., for documenting worksite or other construction-based notes associated with a construction project), a manpower input interface 210E (e.g. for documenting manpower for a given task, timeframe, and/or phase of a construction project), a construction report input interface 210F (e.g., for generating reports from various entities to a construction project during the selected timeframe), a timecards interface 210G (e.g., for documenting various timecards associated with various entities associated with a construction project), a photos input interface 210H (e.g., for uploading and/or otherwise documenting photos or other image data associated with a construction project), and a phone calls input interface 210I (e.g., for creating and/or retrieving logs of phone calls made between parties to a construction project), among other contemplated categorical input interfaces 210 for inputting construction activity data. Some other examples of categorical input interfaces 210 that may be utilized by the software tool include a visitors input interface, a safety violations input interface, an accidents input interface, a deliveries input interface, a plan revisions input interface, a quantities input interface, a productivity input interface, an equipment input interface, a dumpster input interface, a waste input interface, and a delay input interface. Of course, the categorical input interfaces 210 may include various other input interfaces for collecting construction-based data that may be utilized in generating a construction activity log.

The inspections input interface 210B is shown in its collapsed form in FIG. 2A. Upon its selection by a user, an interface for creating an inspection log may be shown. As an example, FIGS. 2B and 2C, respectively, illustrate GUI views 201B, 201C of an expanded GUI for the inspections input interface 210B. As illustrated and as viewed in tandem with the GUI view 201B, the GUI view 201C is a continuation of the GUI view 201B, as if, for example, a user of a client device 104 has scrolled down from the contents of the GUI view 201B to the GUI view 201C.

To provide guidance for a user of a client device 104 to, for example, provide input for an inspections-based construction activity log and/or an inspections-portion of a construction activity log, the inspections input interface 210B includes one or more input fields in which a user of the client device 104 executing the software tool 200 can input data associated with inspections. For example, the inspections input interface 210B may include one or more content attachment buttons 220 (e.g., for attaching files associated with a construction project, such as images, videos, audio recordings, and/or other data files), informative input fields 222 that prompt the user to input information associated with a given inspection (e.g., an inspector field 222A for inputting a name of an inspector, an inspection type field 222B for inputting the type of inspection performed, an inspecting entity field 222C for inputting the entity tasked with the inspection, a location input field 222D for inputting the location of the inspection, an area input field 222E for inputting an area of a given construction project within which the inspection is/was performed, etc.), temporal input fields 224 that prompt the user to input a given timeframe in which an inspection-to-be-logged is occurring/has occurred (e.g., the start time field 224A and the end time field 224B), and/or commentary input fields 226 (e.g., input fields for providing comments associated with an inspection that may be qualitative or quantitative in nature), among other contemplated data input fields.

After a user of a client device 104 executing the software tool 200 has finished attaching files (e.g., via content attachment buttons 220) and/or inputting data into one or more of the fields 222, 224, 226, the user may confirm completion of data entry, via the inspections input interface 210B, by selecting a confirmation indicator 228 (e.g., a button to be selected that indicates confirmation to “Create” an inspections-based construction activity log, based on data input via the inspections input interface 210B). Once confirmed, the data input via the inspections input interface 210B may be utilized to either (i) compile an inspections-based construction activity log or (ii) compile an inspections-based portion of a construction activity log.

The example categorical input interface 210 of FIGS. 2B, 2C (e.g., the inspections input interface 210B) is only illustrated for purposes of example. Other types of categorical input interfaces 210 (e.g., the categorical input interfaces 210A, 210C-I, among other contemplated categorical input interfaces 210) may take various other forms that may have like interfaces to those of FIGS. 2B, 2C (e.g., the content attachment button 220 and fields 222, 224, 226). However, it is more likely that the other categorical input interfaces 210 may have other additional and/or dissimilar input fields, in comparison to those of the inspections input interface 210B illustrated in FIGS. 2B, 2C. To that end, input fields included in any categorical input interfaces 210 may be input fields that are configured to prompt a user of a client device 104 to input any data that is relevant to the particular type of construction activity to be logged.

Returning now to FIG. 2A, after a user of a client device 104 executing the software tool 200 has finished inputting data to the software tool 200 via the categorical input interface(s) 210 (e.g., by expanding individual categorical input interfaces 210 and inputting data therein, as discussed with respect to FIGS. 2B, 2C), the user of the client device 104 may indicate to the software tool 200, via input to a confirmation indicator 218 that data entry is complete. Accordingly, a construction activity log may be compiled based on the data input to the software tool 200. For example and as illustrated, the confirmation indicator 218 may prompt the user of the client device 104 to “Complete Day,” and, accordingly, end data entry for a given timeframe (e.g., a day). The input data is then used to compile the construction activity log.

While these software tools for generating construction activity logs are useful in assisting a user of a client device 104 in inputting some data for logging (and subsequently organizing such data), this process of manually logging construction data on a continual basis is often cumbersome and time consuming for every party to the construction project who need to log at least some category of construction data within a given timeframe.

With such a wide array of data associated with a given construction project, it is, understandably, a very time consuming and difficult task for an individual or group to compile this data, when the same individual or group is also responsible for executing construction tasks for the construction project. To that end, due to the breadth of data to be sifted through for generating construction activity logs, some important data points may be accidentally omitted, due to the undersampling of information used by the log-generating individual or party.

Further still, the risk of human error will exist, when having an individual or small group producing construction activity logs on a regular basis (e.g., on a daily basis). Additionally, if the data is not properly organized, standardized, and/or commonly held, then there is a risk of omission of information, simply because the log-compiling party does not have awareness of the proper formatting of log data. The risk of inconsistent or improperly formatted construction activity logs may result in miscommunications between parties to a construction project.

To address these and other problems with existing construction management software applications, disclosed herein is a new software technology pipeline for automatically generating construction activity logs based on (i) construction data received as input and (ii) a set of predetermined templates for construction activity logs. In this regard, the disclosed software technology may automatically generate construction activity logs of the appropriate type, in the appropriate format, and using the appropriate information, based on various input data as discussed in further detail below.

At a high level, the disclosed technology pipeline may involve (i) using one or more generative AI models to determine a type of construction activity log to be generated and (ii) using the one or more generative AI models to generate a construction activity log corresponding to the type of construction activity log that was determined. Each of the types of construction activity logs may be associated with one or more predetermined log templates for a type of construction activity log.

In a first stage of the new software technology pipeline, the one or more generative AI models may receive, as input, a first prompt that includes construction-based input data for use in generating a construction activity log and a request to determine a type of construction activity log to generate based on the construction-based input data. Such construction-based input data may include data that is associated with one or more software tools of a construction management software application (e.g., registration and/or setup data associated with a construction project, data input into software tools related to the construction project), contextual data inferred from use of one or more software tools of a construction management software application (e.g., data derived from activity tracked via one or more software tools, aggregate and/or comparative data that is determined based on data captured by the construction management software application, etc.), media content in a data storage layer of one or more of a back-end computing platform, a client device, or combinations thereof (e.g., audio/visual content recorded during the course of a construction project, such as videos, audio recordings, photos, etc.), usage data associated with use of the construction management software application by a party to a construction project, communications made in association with a construction project (e.g., e-mails associated with user accounts, phone calls associated with user accounts, messages from a messaging application of the construction management software application, etc.), user data associated with users that have access to a given project managed via the construction management software application and have entered any of the aforementioned data (e.g., user profile data, indications of user roles in a given construction project, etc.), other data objects in a data storage layer of one or more of a back-end computing platform, a client device, or combinations thereof (e.g., invoices, specifications, BIM files, etc.), among other construction-based data.

Based on an analysis of the construction-based input data, the one or more generative AI models determines, in a first stage of the new software technology pipeline, a type of construction activity log that is to be generated in a second stage. Accordingly, the one or more generative AI models may output an indication of the type of construction activity log to be generated. This output may then be utilized for selection of a template for a construction activity log to be utilized by the one or more generative AI models in the second stage to generate a construction activity log based on the construction-based input data.

The construction-based input data, which may be utilized in both the first and second stages, may be a specific set of data that is indicated by a user of a client device. In this regard, the software technology disclosed herein may be utilized within a software tool in which a user indicates a set of data to be utilized in generating a construction activity log for a given task or set of tasks and/or over a given timeframe. The indication of this specific data may be performed by (i) a user of a client device selecting data for use as input for the one or more generative AI models and/or (ii) a user of a client device requesting data stored on a data storage layer of a back-end platform and/or another client device for inclusion as input for the one or more generative AI models.

Alternatively, in some examples, the construction-based input data may be a set of data that may not be specifically defined by a user of a client device. Rather, the construction-based input data may include data that was defined elsewhere within the construction management software platform and was associated with the construction project. To that end, the construction-based input data may comprise any data stored on data storage layer(s) of any back-end platform 102 and/or client device 104 that is associated with a given construction project for which a construction activity log is to be generated.

In some such examples, the construction-based input data may include all, or substantially all, of the data associated with a given construction project within the construction management software platform. In this scenario, a user may provide a request input (e.g., via a client device) to the construction management software to generate a construction activity log based on construction-based input data that is provided by the user and/or obtained from the construction management software platform. The request input and construction-based activity data are then used to generate a prompt for the one or more generative AI models to select a type of construction activity log that corresponds to the user's request. In this regard, a request input may comprise a temporal request (e.g., a timeframe within which a user requests a construction activity log), a type request (e.g., language indicating a type of construction activity log a user desires, whether or not said language conforms to a predetermined type of construction activity log), a party-based request (e.g., language indicating a party to the construction project with whom the user desires a log of the party's activity), among other language to be input to a generative AI model that may direct the model's output.

The types of construction activity logs that can be determined, based on the user request and the construction-based input data, may include any construction activity log that documents construction activity, within a given period of time and/or during any phase(s) of a construction project. To that end, such types of construction activity logs may include a worksite conditions-based type of activity log (e.g., a weather-based type of log, a dumpster-based type of log, a waste-based type of log, etc.), a task-based type of log (e.g., an inspections-based type of log, a construction report-based type of log, a plan revisions-based type of activity log, a productivity-based type of log, a visitors-based type of log, etc.), a timing-based type of activity log (e.g., a scheduled work-based type of log, a timecards-based type of log, a delay-based type of log, etc.), a quantity-based type of activity log (e.g., a manpower-based type of log, a material quantities-based type of log, an equipment-based type of log, etc.), a quality and/or safety-based type of activity log (e.g., a safety violations-based type of log, an accidents-based type of log, etc.), a data object-based type of activity log (e.g. a notes-based type of log, a photos-based type of log, a phone calls-based type of log, etc.), among other contemplated types of construction activity logs.

This output of the type of log to be generated may be used to determine which template in a set of predetermined templates for construction activity summaries should be used, in conjunction with the construction-based input data, for the automatic generation of an output construction activity log. Each of the predetermined templates for construction activity summaries may be associated with a respective type of construction log. For example, a weather log template may be associated with a weather-based type of log, an inspections log template may be associated with an inspections-based type of log, a delay log template may be associated with a delay-based type of log, a manpower log template may be associated with a manpower-based type of log, etc.

Each of the predetermined templates for construction activity summaries may comprise a set of data fields that are to be filled with data that is generated by the one or more generative AI models in the second stage of the software pipeline discussed herein. In this regard, the one or more generative AI models may extract information from the construction-based input data based on an analysis of the input construction-based data, and use said information to generate inputs to the selected template, in view of the input fields presented within the selected predetermined template of a construction activity log.

For example, each of the predetermined templates for construction activity summaries may comprise one or more of content attachment options (e.g., for attaching files associated with a construction project, such as images, videos, audio recordings, and/or other data files), informative input fields for receiving generated input information associated with a given type of construction activity log (e.g., a field for inputting a generated name of an individual performing a given construction activity to be logged, a sub-type field for inputting a sub-type of the type of construction activity to be logged, an entity field for inputting a generated entity tasked with the construction activity to be logged, a location field for inputting a generated location of the inspection, etc.), temporal input fields for receiving input representative of a given timeframe in which an construction activity to be logged is occurring/has occurred (e.g., a start time field and an end time field), and/or commentary input fields (e.g., input fields for providing comments associated with an inspection that may be qualitative or quantitative in nature, as generated by the second instance of a generative AI model), among other contemplated data input fields.

After generating the construction activity log via the one or more generative AI models, the disclosed software technology may cause a client device 104 to present the generated construction activity log to a user of the client device 104. Additionally or alternatively, the back-end computing platform 102 and/or a client device 104 may store the construction activity log on a respective storage layer thereof.

In a first example embodiment of software technology for generating construction activity logs, the one or more generative AI models may take the form of a single generative AI model that performs both the first stage and the second stage of the software pipeline discussed herein. In such examples, the input to the generative AI model during the first stage and the input to the generative AI model during the second stage may differ, and similarly so for the respective outputs. The input during the first stage comprises a first prompt that includes the construction-based input data and the request to determine the type of construction activity log to be generated. In this regard, the first prompt may be generated by the back-end platform 102 that receives the component input data (e.g., from a client device 104). Based on the first prompt, the generative AI model outputs an indication of the type of construction activity log to create. This indication may then be used by the back-end platform 102 to select a template that corresponds to the indicated type of construction activity log. In the second stage of the software pipeline, the back-end platform 102 may generate a second prompt that includes the selected template, some or all of the construction-based input data included in the first prompt, and a request to generate a construction activity log of the determined type. The generative AI model then generates and outputs a generated construction activity log based on the second prompt.

In a second embodiment of software technology for generating construction activity logs, the one or more generative AI models may take the form of a first generative AI model that is utilized during the first stage of the software technology pipeline and a second generative AI model that is utilized during the second stage of the software technology pipeline. In such examples, the input to the first generative AI model during the first stage and the input to the second generative AI model during the second stage may differ as noted above. In this regard, the first prompt discussed above may be used as input to the first generative AI model and the second prompt discussed above may be used as input to the second generative AI model.

In the second embodiment that includes the first and second generative AI models, the first and second generative AI models may be of a differing type and/or may be differently trained, with respect to one another. For example, the first generative AI model may be a generative AI model that is trained, tuned, or otherwise configured to receive the first prompt including construction-based input data and a request, and then determine a type of construction activity log to be generated based on the received construction-based input data. The first generative AI model may take many of various forms, which will be discussed in more detail below.

The second generative AI model may comprise one or more generative AI models that are trained, tuned, or otherwise configured to receive the second prompt including construction-based input data, an activity log template, and a request, and then generate and output a generated construction activity log in accordance with the template. In one example, the second generative AI model may be a single model that receives, as input, the second prompt as discussed above and then generates and outputs the construction activity log according to the template.

Alternatively, the second generative AI model may comprise a set of type-based generative AI models, each associated with a type of construction activity log and/or its associated predetermined template for a construction activity log. In this regard, rather than selecting a given template for the construction activity log to be generated, the back-end computing platform 102 may select a type-based generative AI model from the set, to be used as the second generative AI model in the second stage of the pipeline. In such examples, the selected second generative AI model receives, as input, a second prompt that includes the construction-based input data and a request, and then generates and outputs a construction activity log of the given type.

Each of the various generative AI models discussed herein may take any of various forms. For example, the discussed AI models may comprise any of various types of generative AI models (e.g., transformer-based models such as large language models (LLMs) and/or large multimodal models, diffusion models, generational adversarial networks, variational autoencoders, etc.), which may themselves comprise underlying machine-learning models such as neural networks. Further, the discussed one or more of the generative AI models could comprise a pre-trained generative AI model, a pre-trained generative AI model that is fine-tuned using domain-specific training data (e.g., training data that correlates historic construction-based data with types of construction activity logs), or a generative AI model that is trained in the first instance using domain-specific training data, among other possibilities. In this respect, the fine-turning and/or training of the generative AI models may involve any of various types of machine-learning techniques, including but not limited to supervised, self-supervised, and/or unsupervised learning techniques.

In particular, both off-the-shelf and customized LLMs may be of use for implementing the generative AI models disclosed herein. A LLM refers to a complex machine learning model that utilizes AI accelerator hardware to process vast amounts of text data, which may be scraped from a variety of sources, such as, but not limited to, the Internet. LLMs utilize artificial neural networks comprising millions or even billions of weights, which are then used for one or more of self-supervised learning, semi-supervised learning, or combinations thereof. LLMs operate by taking an input text and repeatedly predicting the next word input by the input text; the LLM can then review the input text versus the predictions to rank its accuracy and “learn” how to “speak” in the context of the scenario of the input text. Examples of LLMs include, but are not limited to including, Generative Pre-trained Transformer (GPT) models (e.g., GPT-3, GPT-3.5, GPT-4, GPT-4o ChatGPT), pathways language models (PaLM), Large Language Model Meta AI (LLaMA), BigScience Large Open-science Open-access Multilingual Language Model (BLOOM), Bidirectional Encoder Representations from Transformers (BERT), among other known models and/or techniques.

Thus, as generative AI models (such as LLMs) are immensely useful in both predicting text and automatically generating content based on a contextual input, the systems and methods disclosed herein may utilize generative AI models in automatically generating construction activity logs, by leveraging construction-based data. By utilizing historic construction project data that has been previously input to the back-end computing platform 102, the generative AI models may be trained with the contextual language and contextual data that is specific to the construction management software application and the various construction-based industries that use it. For example, the generative AI models may “learn” the language of the various software tools provided by the platform, including the general language of the construction industries themselves (e.g., specific construction trades such as plumbing, electrical, concrete, etc.). In this way, the generative AI models may be enabled to predict and/or generate text that is comparable to text that would be provided by a worker who, historically, compiled the construction activity logs.

Training and/or retraining of generative AI models, as disclosed herein, may include fine-tuning the generative AI models based on the specific data sets associated with, for example, a construction management software application. To that end, “fine tuning,” generally refers to a process of re-training a more generic, pre-trained generative AI model, based on a specific dataset; said fine-tuning may allow the generative AI model to adapt to the specific context of an industry and/or platform. For example, training and/or re-training of the generative AI models, disclosed herein, may include fine tuning the generative AI models based on specific, construction-based data sets. By employing such fine-tuning of generative AI models, the generative AI models may be configured to “speak” the language of a specific industry and/or computing platform, such as the construction industry and/or a computing platform associated therewith. Processes for fine tuning a generative AI model may take many of various forms, including, but not limited to, instruction tuning processes, memory tuning processes, among other fine tuning processes.

Further still, in the course of generating construction activity logs, the generative AI models may be retrained based on new inputs to the computing platform during the course of a construction project. Additionally, the generative AI models may re-ingest the output data, which may or may not include user modification, and learn various restraints/parameters therefrom (e.g., rankings of importance, ordering of data, etc.). For instance, the computing platform and/or an application for generating said construction activity logs may provide a input interface for the user to provide input associated with the generated summary, such as, but not limited to an approval that the summary is accurate, a disapproval of the summary, text edits and/or ordering edits to the summary, among other forms of user input associated with the generated summary. The generative AI models may then ingest the edited summary, learn from the edits, and be able to better predict what the user wants from his/her/their summaries, by learning from, for example, how the user ranked the importance of aspects of the summary.

In some implementations, such retraining may comprise the generative AI model being configured to interact with a reinforcement model that is configured to (i) receive, as input, data defining a given user's interactions with a construction activity log that is generated by the generative AI model, (ii) generate a “reward” value (or “score” value) for the construction activity log based on the given user's interactions (e.g., the extent to which the user modified the activity log), and (iii) feed the reward value back to the generative AI model, which then uses the reward value and the user's interactions to refine its generation of construction activity logs going forward. This functionality is commonly referred to as reinforcement learning with human feedback (RLHF).

As a practical example, consider a use case of the disclosed software technology wherein the construction-based input data included in the first prompt that is provided to the one or more generative AI models includes (i) a video recording of an inspection of a newly laid foundation of a construction project, (ii) an associated audio recording with commentary from an inspector regarding the inspection, (iii) recordings of a phone call from the inspector to another party to the construction project, (iv) a specification for the construction project that includes dimensions of the aforementioned foundation of the construction project, and (v) a materials listing that includes the requisite material types and quantities needed for construction of the aforementioned foundation. Based on this information included in the first prompt, the one or more generative AI models may determine that the type of construction activity log to be generated is an inspections log.

Accordingly, a template prompt may then be generated to instruct a second instance of a generative AI model to utilize an inspections log template of the set of predetermined templates for construction activity logs. Then, the second instance of the generative AI model may generate input to the inspections log template, based on the construction-based input data. For example, the second instance of a generative AI model may determine input to a temporal field of the inspections log template by analyzing metadata associated with time/date from the video recording and/or associated audio recording of the inspection. Further still, the second instance of the generative AI model may determine input to entity-based input fields of the inspections log template (e.g., name of inspector, name of inspecting entity), based on data generated from an analysis of the phone call recordings, audio recordings, etc. and/or metadata thereof that indicates a creator of the media file data. Additionally, based on an analysis of the specification and materials listings input as the construction-based input data, the second instance of the generative AI model may determine input to a quantity field of the inspections log template that indicates the amount of materials either used or needed, up to this point, for construction of the foundation. In some additional examples, the second instance of a generative AI model may utilize all construction-based input data (but particularly the video and audio recordings) to generate a summary of the completed inspection, by utilizing language generation technology implemented during the second instance of a generative AI model. This summary may include both quantitative and qualitative observations based on the completed inspection, as generated by the second instance of the generative AI model.

Accordingly, by utilizing the disclosed technology, parties to a construction project may greatly improve their construction activity logging and documentation capabilities by utilizing generative AI models to assist in content generation. Further, by implementing the predetermined templates as guideposts within the execution of various generative AI models disclosed herein, construction activity logs of all types may be generated using the correct template to thereby facilitate the accurate logging of construction activity data. Further, a user of a construction management software application that is less familiar with construction activity logging may access features or formats (e.g., types of activity logs) not previously known to the user, decreasing the learning curve for using the construction management software application.

Further still, by utilizing the disclosed software technology for generating construction activity logs, not only can a user's time be conserved via intelligent generation of construction activity logs, based on construction-based input data, but standardization of construction activity logs can be achieved. Standardization of activity log formatting and included data may lead to improved consistency of documentation over the course of a construction project and/or may make construction activity logs more accessible to a wider audience of users/parties. Such standardization can be achieved both across a given project or party (over multiple projects) and across the construction management software application more globally.

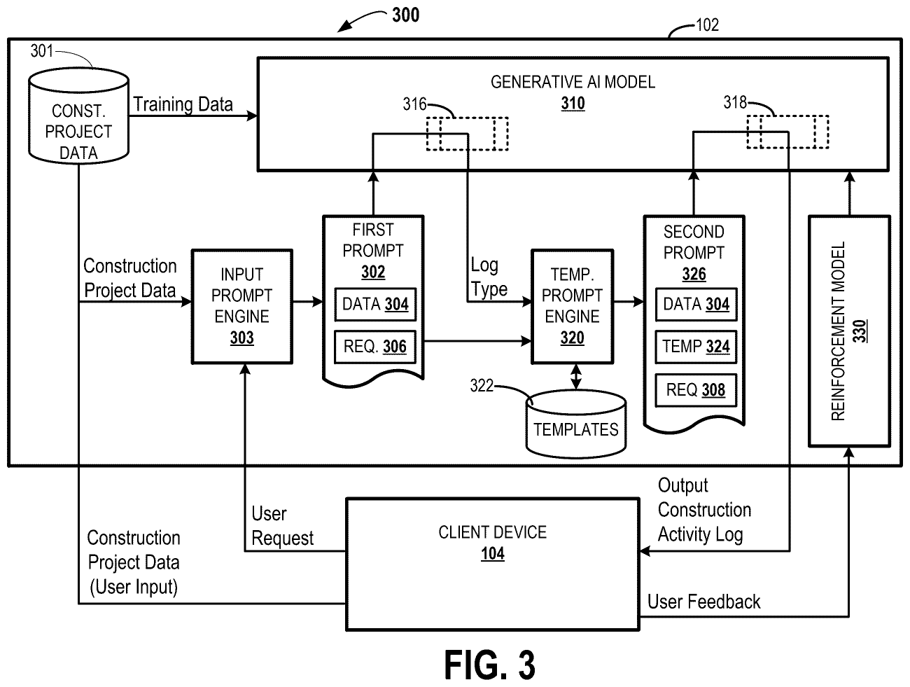

Turning to FIG. 3, one example of a software pipeline 300 that may be utilized to automatically generate a construction activity log is illustrated. The software pipeline 300 and/or any associated processes may be carried out by any combination of software components within the disclosed network environment 100, including software components included in one or more client device(s) 104, back-end computing platform(s) 102, or combinations thereof.

As shown, the example software pipeline 300 may include an input prompt engine 303, which is depicted in FIG. 3 as part of the back-end platform 102. The input prompt engine 303 may be configured to generate a first prompt 302, which may be input to a generative AI model 310 during a first stage 316 of the software pipeline. The input prompt engine 303 may generate a construction-based input dataset 304 for the first prompt 302 from construction project data 301 (“Construction Project Data”) that is stored on a data storage layer of the back-end computing platform 102. Additionally or alternatively, the input prompt engine 303 may generate the construction-based input dataset 304 for the first prompt 302 based on construction project data that is received by the back-end computing platform 102 from a client device 104 (“Construction Project Data (User Input)”). In such examples, it is contemplated that construction project data received from the client device 104 is stored to the data storage layer of the back-end computing platform 102 and then loaded by the input prompt engine 303. However, the construction project data utilized as the basis for the construction-based input dataset 304 may take various other forms and may originate from another source.

Additionally, the input prompt engine 303 may generate a request 306, for use as part of the first prompt 302. The request 306 may be a request to determine a type of construction activity log to be generated. In some implementations, the request 306 may be received by the input prompt engine 303 via, for example, an input to a client device 104 that is subsequently sent or relayed to the back-end computing platform 102 (e.g., “User Request”) into which the software pipeline 300 is integrated. Alternatively, the request 306 may be triggered automatically by the construction management software platform (or a software tool thereof) on some regular basis, such that regularly scheduled construction activity logs are automatically generated (e.g., on an automatic daily basis). The request 306 may take various other forms, as well, and may originate from a variety of other sources.

The generative AI model 310 is a model that is configured to receive, during the first stage of the software pipeline 300, the first prompt 302 and output a determination of a type of construction activity log to be generated. In this regard, the output determination of the generative AI model 310 may be based on (i) the construction-based input dataset 304 and (ii) the request 306. In such examples, the generative AI model 310 may determine a type of log (“Log Type”) that is to be generated by the generative AI model 310 during a second stage 318 of the software pipeline 300. For example, the generative AI model 310 may determine a type of log to be generated based on an analysis of the contents of the construction-based input data set 304 (e.g., an analysis of a video by the generative AI model 310 determines that the video is a recording of an inspection and, thus, the type of log to be generated is an inspections-type of log). Additionally or alternatively, the generative AI model 310 may utilize contents of the request 306 in determining the type of log to be generated (e.g., a user request of the request 306 indicates a category of log that the user desires to be generated).

The determined type of log to be generated is then output, after execution of the first stage 316 of the software pipeline 300, to a template prompt engine 320. The template prompt engine 320 utilizes the type of log to be generated to select a predetermined template for a construction activity log that is to be utilized in generating the requested construction activity summary. This selection may include (i) analyzing the determined type of log to be generated, (ii) determining which predetermined template for the construction activity log should be utilized in generating the determined type of construction activity log, and (iii) accessing the predetermined template for the construction activity log from a set of predetermined templates for a construction activity log, which, for example, may be stored on a template database 322 of a data storage layer of the back-end computing platform 102. The template prompt engine 320 may then utilize the accessed template 324, along with the construction-based input dataset 304 and a request 308 to generate a second prompt 326 for input to the generative AI model 310.

The second prompt 326 is input to the generative AI model 310 at the second stage 318 of the software pipeline 300. Based on the second prompt 326 and the contents thereof, the generative AI model 310 outputs a generated construction activity log of the type indicated in the output of the first stage 316 (“Output Construction Activity Log”).

In line with the discussion above, the generative AI model 310 may comprise any of various types of generative AI models, examples of which may include a transformer-based model such as an LLM and/or large multimodal model, a diffusion model, a generational adversarial network, and/or a variational autoencoder, each which may be comprised of underlying machine-learning models such as neural networks. Further, the generative AI model 310 could comprise a pre-trained generative AI model, a pre-trained generative AI model that is fine-tuned using domain-specific training data, or a generative AI model that is trained in the first instance using domain-specific training data, among other possibilities. In this respect, the fine-turning and/or training of the generative AI model 310 may involve any of various types of machine-learning techniques, including but not limited to supervised, self-supervised, and/or unsupervised learning techniques.

In some implementations, the generative AI model 310 may also be configured to interact with a reinforcement model 330 that is configured to (i) receive, as input, data indicating a given user's interactions with a construction activity log that was generated by the generative AI model 310 (“User Feedback”), (ii) generate a “reward” value (or “score” value) for the generated construction activity log based on the given user's interactions (e.g., storing/sharing the generated construction activity log, editing/correcting the generated construction activity log, approving/denying the construction activity log, approving/denying the type of construction activity log selected, etc.), and (iii) feed the reward value back to the generative AI model 310, which then uses the reward value to refine its generation of construction activity logs going forward. This functionality is commonly referred to as reinforcement learning with human feedback (RLHF).

In these implementations, the generative AI model 310 may function to generate a “target user interaction” for a construction activity log that is generated, and the reinforcement model 330 may be configured to generate the reward value for the construction activity log by evaluating the generated construction activity log with a revised version of the construction activity log, relative to the target user interaction (e.g., by comparing the actual user interaction to the target user interaction and determining the reward value based on the difference between the actual user interaction and the target user interaction). In this respect, the reward value may quantify the desirability of construction activity logs based on whether the user interactions with such construction activity logs align with expected user interactions. The input to the reinforcement model 330 and/or the reward values that are output by the reinforcement model 330 may take various other forms as well.

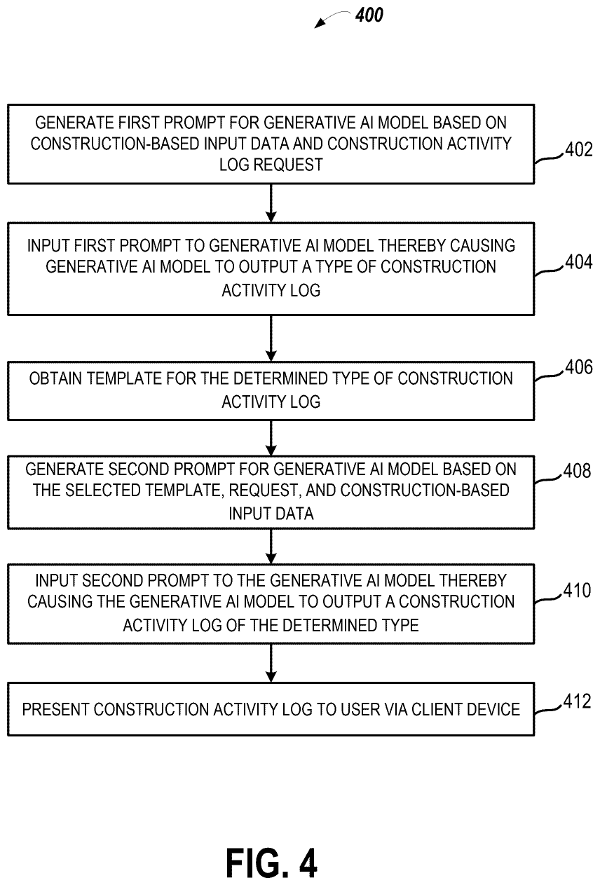

Turning to FIG. 4, example functionality 400 is illustrated in the form of a flow diagram. For purposes of illustration, the example functionality 400 of FIG. 4 is described as being carried out by the back-end computing platform 102 of FIG. 1, which is hosting a construction management software application, but it should be understood that the example functionality 400 of FIG. 4 may be carried out by any computing platform that is capable of running the software disclosed herein (e.g., a client device 104). The functionality 400 may further be carried out by implementing the software pipeline 300 of FIG. 3, via the back-end computing platform 102 (or any other computing platform that is capable of running the software herein) in conjunction with the construction management software application.

Further, it should be understood that the example functionality of FIG. 4 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

Prior to executing the example functionality 400, one or more steps not depicted in FIG. 4 may be executed by the back-end computing platform 102, in preparation for carrying out the example functionality 400. For example, the back-end computing platform 102 may receive a request to automatically generate a construction activity log. Such a request may be received from a client device 104 that is associated with a given user of the construction management software application. The request may take the form of one or more request messages (e.g., one or more HTTP messages) that are sent over a communication path 106 between the client device 104 and the back-end computing platform 102 and, in at least some implementations, the request may comprise one or more messages sent via one or more APIs. The client device 104 may send the request to the back-end computing platform 102 in response to an input received via an I/O component that is a part of, or is in communication with, the client device 104. The input may take any of various forms.

For instance, as one possibility, if the I/O component is a touch screen, the input may be received when the given user taps on an icon (or some other input-control element) that is displayed on the touch screen. As another possibility, if the I/O component is a mouse, the input may be received when the given user (i) moves a cursor displayed on a screen over an icon that is associated with the construction management software application and (ii) clicks on the icon (or other input-control element). As another possibility, if the I/O component is a keyboard, the input may be received when the given user presses a hotkey associated with the construction management software application, enters a command to open the construction management software application via a command prompt, or presses enter (or some other key) to submit credentials (e.g., a username and password) that the given user has typed into one or more text fields configured to receive those credentials. Persons of skill in the art will recognize that the input may also take other forms to cause the client device 104 to send the request to the back-end computing platform 102.

Further, the back-end computing platform 102 may obtain data for use in executing the functionality 400, which may include the construction-based input dataset 304. In practice, this functionality for obtaining the construction-based input dataset 304 may comprise accessing and loading the construction-based input dataset 304 from a data storage layer of the back-end computing platform 102 and/or an external data source, among other possibilities. Further, the construction-based input dataset 304 that is obtained may comprise any project data that can be utilized to generate a construction activity log.

The example functionality 400 may begin at block 402 with the back-end computing platform 102 generating a first prompt (e.g., the first prompt 302) for input to the generative AI model 310, based on and including the construction-based input dataset 304 and the request 306, as discussed above. Then, as illustrated in block 404, the first prompt is input to the generative AI model 310, thereby causing the generative AI model 310 to output a type of construction activity log, based on an analysis of the construction-based input dataset 304.

Based on this first output of the generative AI model 310 (e.g., in a first stage 316 of the software pipeline 300), the back-end computing platform 102 may obtain a template 324 for the determined type of construction activity log, as illustrated in block 406. In practice, this functionality for obtaining the template for the determined type of construction activity log may comprise accessing and loading the construction-based input data from a data storage layer of the back-end computing platform 102 and/or an external data source, among other possibilities.

As illustrated in block 408, the back-end computing platform 102 may then generate a second prompt for the generative AI model 310 that comprises the template for a construction activity log that is associated with the type of construction activity log determined at block 404, the construction-based input dataset 304, and a request 308 to generate a construction activity log of the type corresponding to the template. This second prompt may, in some examples, take the form of the second prompt 326, as discussed above and with respect to FIG. 3.

At block 410, the second prompt (e.g., the second prompt 326), which may include the construction-based input dataset 304, the request 308, and the template 324, is input to the generative AI model 310. Based on an analysis of the construction-based input dataset 304, in view of the selected predetermined template for a construction activity log and the request 308, the generative AI model 310 may then output a generated construction activity log of the type determined by the generative AI model 310 in the first stage of the software pipeline 300.

At block 412, the back-end computing platform 102 causes the generated construction activity log to be presented via a client device associated with a user. The manner in which the back-end computing platform 102 causes generated construction activity log to be presented to the given user may take many of various forms.

For instance, as one possibility, the back-end computing platform 102 may transmit a communication to the client device 104 (e.g., via the communication path 106 shown in FIG. 1 between the back-end computing platform 102 and the client device 104) that instructs the client device 104 to display the generated construction activity log (e.g., on a screen controlled by the client device 104). In practice, this communication may take the form of one or more response messages (e.g., one or more HTTP messages) that are sent over the communication path between the back-end computing platform 102 and the client device 104 and, in at least some implementations, the communication may comprise one or more messages sent via one or more APIs.

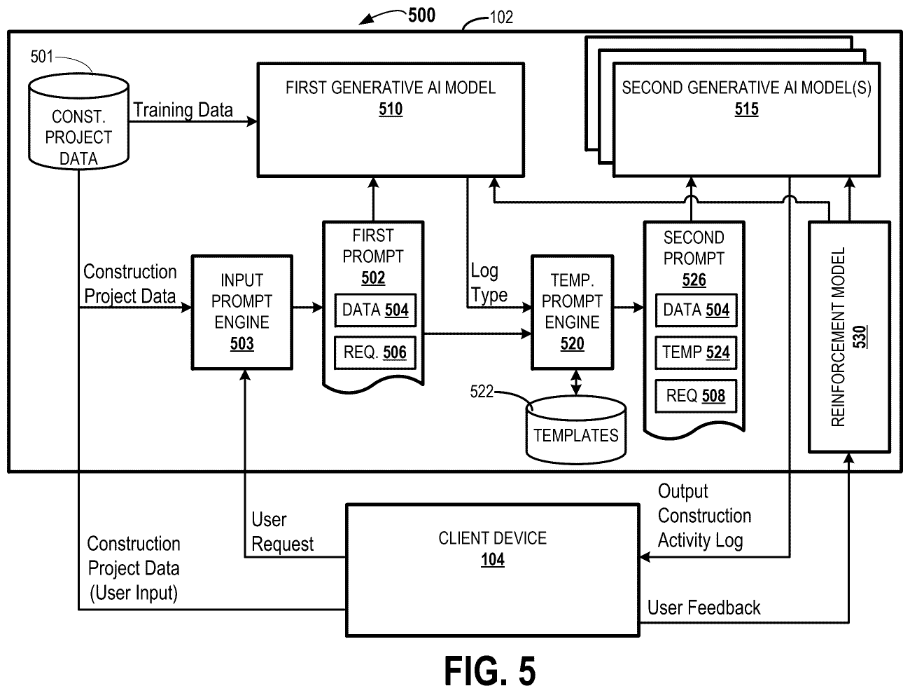

Turning to FIG. 5, another example of a software pipeline 500 that may be utilized to automatically generate a construction activity log is illustrated. The software pipeline 500 and/or any associated processes may be carried out by any combination of software components within the disclosed network environment 100, including one or more client device(s) 104, back-end computing platform(s) 102, or combinations thereof.

As shown, the example software pipeline 500 may include an input prompt engine 503, which is depicted in FIG. 5 as part of the back-end platform 102. The input prompt engine 503 may be configured to generate a first prompt 502, which may be input to a first generative AI model 510 of the software pipeline 500. The input prompt engine 503 may generate a construction-based input dataset 504 for the first prompt 502 from construction project data 501 (“Construction Project Data”) that is stored on a data storage layer of the back-end computing platform 102. Additionally or alternatively, the input prompt engine 503 may generate the construction-based input dataset 504 for the first prompt 502 based on construction project data that is received by the back-end computing platform 102 from a client device 104 (“Construction Project Data (User Input)”). In such examples, it is contemplated that construction project data received from the client device 104 is stored to the data storage layer of the back-end computing platform 102 and then loaded by the input prompt engine 503. However, the construction project data utilized as the basis for the construction-based input dataset 504 may take various other forms and may originate from another source.

Additionally, the input prompt engine 503 may generate a request 506, for use as part of the first prompt 502. The request 506 may be a request to determine a type of construction activity log to be generated. In some implementations, the request 506 may be received by the input prompt engine 503 via, for example, an input to a client device 104 that is subsequently sent or relayed to the back-end computing platform 102 (e.g., “User Request”) into which the software pipeline 500 is integrated. Alternatively, the request 506 may be triggered automatically by the construction management software platform (or a software tool thereof) on some regular basis, such that regularly scheduled construction activity logs are automatically generated (e.g., on an automatic daily basis). The request 506 may take various other forms, as well, and may originate from a variety of other sources.

The first generative AI model 510 is a model that is configured to receive the first prompt 502 and output a determination of a type of construction activity log to be generated. In this regard, the output determination of the first generative AI model 510 may be based on (i) the construction-based input dataset 504 and (ii) the request 506. In such examples, the first generative AI model 510 may determine a type of log (“Log Type”) that is to be generated by the generative AI model 510. For example, the first generative AI model 510 may determine a type of log to be generated based on an analysis of the contents of the construction-based input dataset 504 (e.g., an analysis of a video by the first generative AI model 510 determines that the video is a recording of an inspection and, thus, the type of log to be generated is an inspections-type of log). Additionally or alternatively, the first generative AI model 510 may utilize contents of the request 506 in determining the type of log to be generated (e.g., a user request of the request 506 indicates a category of log that the user desires to be generated).

The determined type of log to be generated is then output to a template prompt engine 520. The template prompt engine 520 utilizes the type of log to be generated to select a predetermined template for a construction activity log that is to be utilized in generating the requested construction activity summary. This selection may include (i) analyzing the determined type of log to be generated, (ii) determining which predetermined template for the construction activity log should be utilized in generating the determined type of construction activity log, and (iii) accessing the predetermined template for the construction activity log from a set of predetermined templates, which, for example, may be stored on a template database 522 of a data storage layer of the back-end computing platform 102. The template prompt engine 520 may then utilize the accessed template 524, along with the construction-based input dataset 504 and a request 508 to generate a second prompt 526 for input to second generative AI model(s) 515.

The second prompt 526 is input to the second generative AI model(s) 515 of the software pipeline 500. Based on the second prompt 526 and the contents thereof, the second generative AI model(s) 515 outputs a generated construction activity log of the type indicated in the output of the first generative AI model 510 (“Output Construction Activity Log”).

The first and second generative AI models 510, 515 may be of a differing type and/or may be differently trained, with respect to one another. For example, the first generative AI model 510 may be a generative AI model that is trained, tuned, or otherwise configured to receive construction-based input dataset 504 and a request, and then determine a type of construction activity log to be generated based on the received construction-based input dataset 504. The first and second generative AI models 510, 515 may take many of various forms, which will be discussed in more detail below.

The second generative AI model 515 may comprise one or more generative AI models that are trained, tuned, or otherwise configured to receive the second prompt 526 and then output a generated construction activity log. In one example, the second generative AI model 515 may be a single model that (i) receives, as input, the second prompt 526 including the selected template 524, and (ii) generates and outputs the construction activity log based on the selected template for a construction activity log. Alternatively, the second generative AI model 515 may be one of a set of type-based generative AI models, each configured to generate a construction activity log of a respective type. In such examples, the back-end computing platform 102 may select the second generative AI model 515 from the set of models based on the determined type of construction activity log that was output by the first generative AI model 510. For example, if the determined type of construction activity log is an inspection log, the back-end computing platform 102 may select the second generative AI model 515 from the set because the selected model is a model configured to generate inspection logs (e.g., based on training data that may include an inspection log template). The template prompt engine 520 may then generate a second prompt for input to second generative AI model 515. However, in an embodiment where the second generative AI model 515 is a type-based model configured to output a log of a specific type, the second prompt might not include an indication of the template 524, which may be unnecessary. Rather the second prompt may include only the construction-based input dataset 504 and the request 508. After receiving the second prompt as input, the second generative AI model may generate and output a construction activity log of the type that it is configured to generate.

In line with the discussion above, the first and second generative AI models 510, 515 may comprise any of various types of generative AI models, examples of which may include a transformer-based model such as an LLM and/or large multimodal model, a diffusion model, a generational adversarial network, and/or a variational autoencoder, each which may be comprised of underlying machine-learning models such as neural networks. Further, the first and second generative AI models 510, 515 could comprise a pre-trained generative AI model, a pre-trained generative AI model that is fine-tuned using domain-specific training data, or a generative AI model that is trained in the first instance using domain-specific training data, among other possibilities. In this respect, the fine-turning and/or training of the first and second generative AI models 510, 515 may involve any of various types of machine-learning techniques, including but not limited to supervised, self-supervised, and/or unsupervised learning techniques.

In some implementations, the first and second generative AI models 510, 515 may also be configured to interact with a reinforcement model 530 that is configured to (i) receive, as input, data indicating a given user's interactions with a construction activity log that was generated by one or both of the first and second generative AI models 510, 515 (“User Feedback”), (ii) generate a “reward” value (or “score” value) for the generated construction activity log based on the given user's interactions (e.g., storing/sharing the generated construction activity log, editing/correcting the generated construction activity log, approving/denying the construction activity log, approving/denying the type of construction activity log selected, etc.), and (iii) feed the reward value back to the generative AI model 310, which then uses the reward value to refine its generation of construction activity logs going forward. This functionality is commonly referred to as reinforcement learning with human feedback (RLHF).

In these implementations, the first and second generative AI models 510, 515 may function to generate a “target user interaction” for a construction activity log that is generated, and the reinforcement model 530 may be configured to generate the reward value for the construction activity log by evaluating the generated construction activity log with a revised version of the construction activity log, relative to the target user interaction (e.g., by comparing the actual user interaction to the target user interaction and determining the reward value based on the difference between the actual user interaction and the target user interaction). In this respect, the reward value may quantify the desirability of construction activity logs based on whether the user interactions with such construction activity logs align with expected user interactions. The input to the reinforcement model 530 and/or the reward values that are output by the reinforcement model 530 may take various other forms as well.

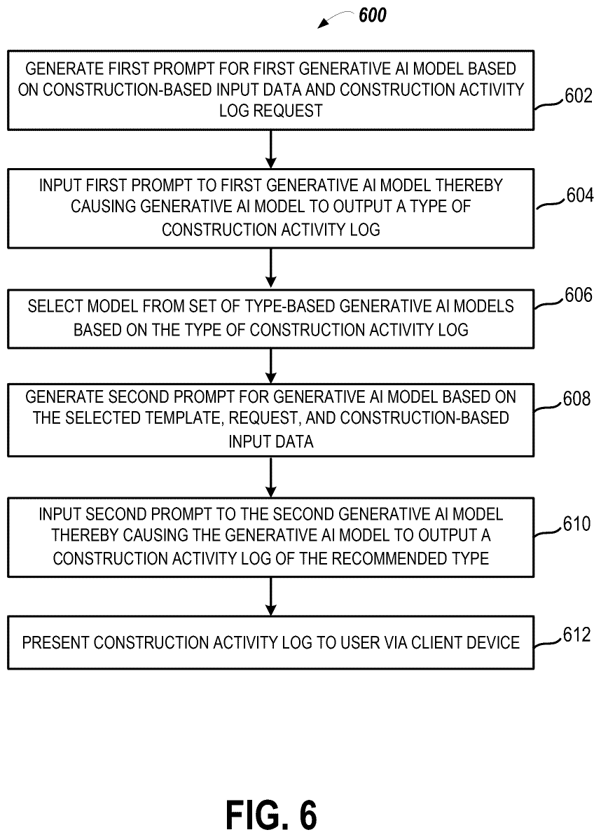

Turning to FIG. 6, example functionality 600 is illustrated in the form of a flow diagram. For purposes of illustration, the example functionality 600 of FIG. 6 is described as being carried out by the back-end computing platform 102 of FIG. 1, which is hosting a construction management software application, but it should be understood that the example functionality 600 of FIG. 6 may be carried out by any computing platform that is capable of running the software disclosed herein (e.g., a client device 104). The functionality 600 may further be carried out by implementing the software pipeline 500 of FIG. 5, via the back-end computing platform 102 (or any other computing platform that is capable of running the software herein) in conjunction with the construction management software application.

Further, it should be understood that the example functionality of FIG. 6 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

Prior to executing the example functionality 600, one or more steps not depicted in FIG. 6 may be executed by the back-end computing platform 102, in preparation for carrying out the example functionality 600. For example, the back-end computing platform 102 may receive a request to automatically generate a construction activity log. Such a request may be received from a client device 104 that is associated with a given user of the construction management software application. The request may take the form of one or more request messages (e.g., one or more HTTP messages) that are sent over a communication path 106 between the client device 104 and the back-end computing platform 102 and, in at least some implementations, the request may comprise one or more messages sent via one or more APIs. The client device 104 may send the request to the back-end computing platform 102 in response to an input received via an I/O component that is a part of, or is in communication with, the client device 104. The input may take any of various forms.

For instance, as one possibility, if the I/O component is a touch screen, the input may be received when the given user taps on an icon (or some other input-control element) that is displayed on the touch screen. As another possibility, if the I/O component is a mouse, the input may be received when the given user (i) moves a cursor displayed on a screen over an icon that is associated with the construction management software application and (ii) clicks on the icon (or other input-control element). As another possibility, if the I/O component is a keyboard, the input may be received when the given user presses a hotkey associated with the construction management software application, enters a command to open the construction management software application via a command prompt, or presses enter (or some other key) to submit credentials (e.g., a username and password) that the given user has typed into one or more text fields configured to receive those credentials. Persons of skill in the art will recognize that the input may also take other forms to cause the client device 104A to send the request to the back-end computing platform 102.

Further, the back-end computing platform 102 may obtain data for use in executing the functionality 600, which may include the construction-based input dataset 504. In practice, this functionality for obtaining the construction-based input dataset 504 may comprise accessing and loading the construction-based input dataset 504 from a data storage layer of the back-end computing platform 102 and/or an external data source, among other possibilities. Further, the construction-based input dataset 504 that is obtained may comprise any project data that can be utilized to generate a construction activity log.

The example functionality 600 may begin at block 602 with the back-end computing platform 102 generating a first prompt (e.g., the first prompt 502) for input to the first generative AI model 510, based on and including the construction-based input dataset 504 and the request 506, as discussed above. Then, as illustrated in block 604, the first prompt is input to the first generative AI model 510, thereby causing the first generative AI model 510 to output a type of construction activity log, based on an analysis of the construction-based input dataset 504.

Based on this output of the first generative AI model 510, the back-end computing platform 102 may select, from a set of type-based generative AI models each configured to generate a construction activity log of a give type, a second generative AI model 515, as illustrated in block 606. In practice, this functionality for selecting the second generative AI model 515 from the set may comprise accessing and loading the second generative AI model 515 from a data storage layer of the back-end computing platform 102 and/or an external data source, among other possibilities.

As illustrated in block 608, the back-end computing platform 102 may then generate a second prompt for the second generative AI model(s) 515 that comprises the construction-based input dataset 504 and a request 508 to generate a construction activity log. This second prompt may be similar to the second prompt 526, as discussed above and with respect to FIG. 5, but without an indication for a template for a type of construction activity log.

At block 610, the second prompt (e.g., the second prompt 526), which may include the construction-based input dataset 504and the request 508, is input to the second generative AI model(s) 515. Based on an analysis of the construction-based input dataset 504, in view of the request 508, the second generative AI model(s) 515 may then output a generated construction activity log of the type that the second generative AI model 515 is configured to generate.

At block 612, the back-end computing platform 102 causes the generated construction activity log to be presented via a client device associated with a user. The manner in which the back-end computing platform 102 causes generated construction activity log to be presented to the given user may take many of various forms.

For instance, as one possibility, the back-end computing platform 102 may transmit a communication to the client device 104 (e.g., via the communication path 106 between the back-end computing platform 102 and the client device 104) that instructs the client device 104 to display the generated construction activity log (e.g., on a screen controlled by the client device 104). In practice, this communication may take the form of one or more response messages (e.g., one or more HTTP messages) that are sent over the communication path between the back-end computing platform 102 and the client device 104 and, in at least some implementations, the communication may comprise one or more messages sent via one or more APIs.

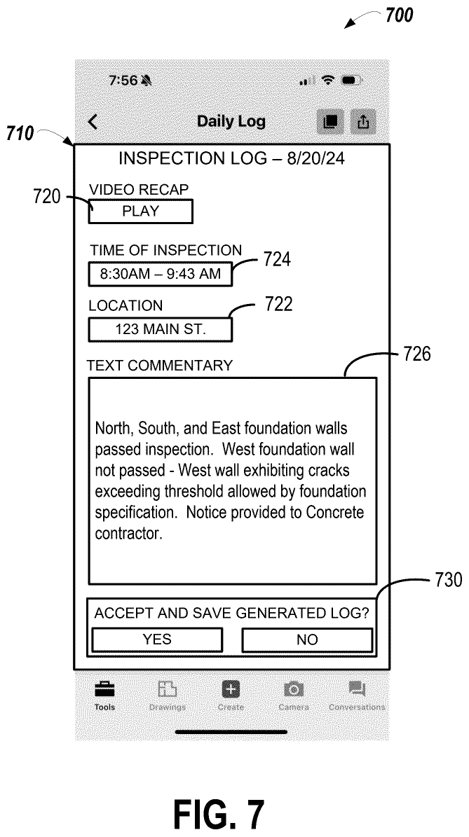

FIG. 7 depicts a GUI view 700 of an example construction activity log 710 data object as generated by the computing systems and methods disclosed herein. As illustrated, the construction activity log 710 may include one or more filled out data fields that include data that was generated by one or more of the disclosed generative AI models and input into a predetermined template for a construction activity log.

The example construction activity log 710 recalls the example generation of an inspection-type of construction activity log, discussed above. To that end, presenting one of the data entries generated for the construction activity log 710, a media file selector field 720 may be included in the construction activity log 710, wherein a user of a client device 104 displaying the construction activity log 710 can provide some input and, in response, the client device 104 may present the user with media content edited or curated, based on construction-based input data, for the generated construction activity log 710. For example, a generative AI model may utilize video recordings, input as construction-based input data, to generate an edited video representation of the inspection or a summary of the inspection. The media file selector field 720 may take any of various forms and may be utilized for presenting the user of the client device 104 with various other forms of media associated with the example inspection (e.g., photos, audio files, BIM files, etc.).

In some examples, the construction activity log 710 may include one or more temporal fields 724 that are filled with temporal data that is generated via a generative AI model, as disclosed herein. For example, data contained in the construction-based input data may be utilized to determine or derive a time in which the inspection to be logged was performed. Further still, for example, the generative AI model may determine this temporal data based on metadata associated with other construction-based input data (e.g., media files) input to the generative AI model. A temporal field 724 may take various other forms, as well, that indicate some timeframe in which the inspection occurred or is occurring.

Further, the construction activity log 710 may include one or more informative fields 722 that include factual data associated with the inspection to be logged. In the example shown, the informative field 722 is populated by data indicative of a location at which the inspection to be logged was performed. This information populating the informative field may be generated by a generative AI model based on the construction-based input data or data derived therefrom (e.g., location data, such as GPS or IP-based data, associated with data files input to the generative AI model).

Additionally, informative fields for the construction activity log 710 may take various other forms, such as a field for a name of an inspector, a field for an inspecting entity, a reason for the inspection, etc. Each of these other example informative fields may be similarly populated by data that is generated by a generative AI model in response to an analysis of construction-based input data.

Further, the data input fields of the construction activity log 710 may include one or more commentary fields 726 that include commentary that is generated by a generative AI, based on an analysis of the construction-based input data. The data generated for the commentary fields 726 may be generated via one or more language processing techniques of generative AI models, such as, but not limited to, natural language processing (NLP). As illustrated, the example commentary field 726 may be presented to a user of a client device 104 via, for example, the text commentary field 726 as illustrated in FIG. 7. Commentary fields 726 may take various other forms (e.g., an audio commentary playing back generated commentary to a user, a graphic representation of the contents of generated commentary, etc.) and may be generated via various other modelling techniques.

In some examples, the construction activity log 710 may be overlain with a prompt 730 that solicits qualitative input from a user of the client device 104 that is displaying the construction activity log 710. In the illustrated form, the prompt 730 queries the user as to whether or not he/she/they approves of the generated construction activity log 710 and if it should be saved (e.g., stored to data storage layer of one or more of a back-end computing platform 102, a client device 104, or combinations thereof).

Input via the prompt 730 provides a functional purpose to the user (e.g., rejecting/accepting the construction activity log 710, prompting to save the construction activity log 710, etc.), while also providing an input mechanism for retraining a generative AI model that was used in generating the construction activity log 710. For example, input data received via the prompt 730 may be utilized by a reinforcement model, as discussed above, for retraining the generative AI model based on user feedback of the generated construction activity log 710. Other forms of direct user feedback (editing of generated data input into fields, deletion of data, quick closing of media data prior to completion, etc.) or indirect user feedback (time spent viewing the generated log, whether the user has revisited the generated log, etc) may also be utilized for retraining via a reinforcement model. Such reinforcement models may take various forms and utilize various techniques, such as, but not limited to, RLHF.

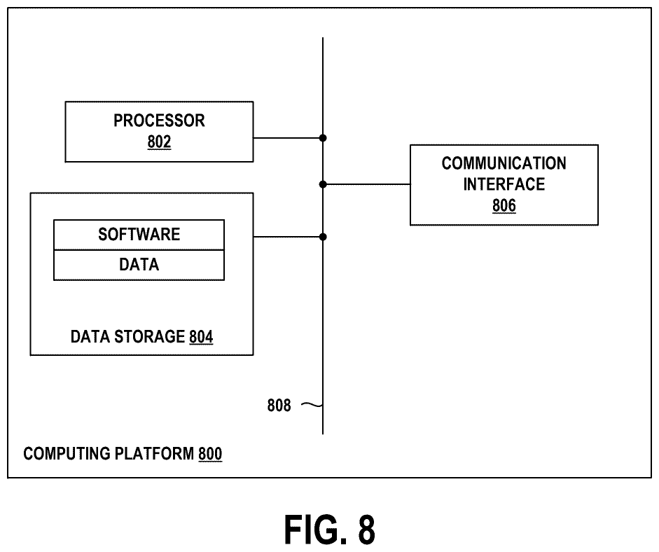

Turning now to FIG. 8, a simplified block diagram is provided to illustrate some structural components that may be included in an example computing platform 800 that may be configured to perform the platform-side functions disclosed herein. At a high level, the example computing platform 800 may generally comprise any one or more computer systems (e.g., one or more servers) that collectively include one or more processors 802, data storage 804, and one or more communication interfaces 806, each of which may be communicatively linked by a communication link 808 that may take the form of a system bus, a communication network such as a public, private, or hybrid cloud, or some other connection mechanism. Each of these components may take various forms.

For instance, the one or more processors 802 may comprise one or more processor components, such as one or more central processing units (CPUs), graphics processing units (GPUs), neural processing units (NPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 802 could comprise processing components that are distributed across a plurality of physical computing devices connected via a network, such as a computing cluster of a public, private, or hybrid cloud.

In turn, the data storage 804 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 804 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 8, the data storage 804 may be capable of storing both (i) program instructions that are executable by the one or more processors 802 such that the example computing platform 800 is configured to perform any of the various functions disclosed herein (including but not limited to any of the server-side functions discussed above), and (ii) data that may be received, derived, or otherwise stored by the example computing platform 800.

The one or more communication interfaces 806 may comprise one or more interfaces that facilitate communication between the example computing platform 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 800 may additionally have an Input/Output (I/O) interface that includes or provides connectivity to I/O components that facilitate user interaction with the example computing platform 800, such as a keyboard, a mouse, a trackpad, a display screen, a touch-sensitive interface, a stylus, a virtual-reality headset, and/or one or more speaker components, among other possibilities.

It should be understood that the example computing platform 800 is one example of a computing platform that may be used with the examples described herein. Numerous other arrangements are possible and contemplated herein. For instance, in other examples, the example computing platform 800 may include additional components not pictured and/or more or less of the pictured components.

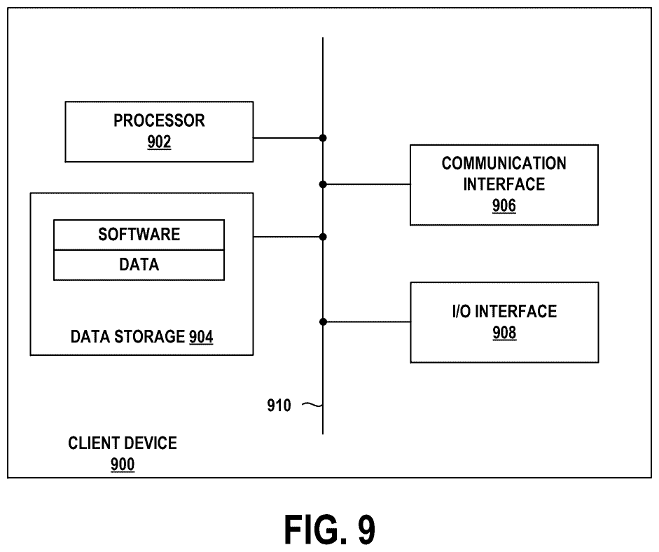

Turning next to FIG. 9, a simplified block diagram is provided to illustrate some structural components that may be included in an example client device 900 that may be configured to perform some the client-side functions disclosed herein. At a high level, the example client device 900 may include one or more processors 902, data storage 904, one or more communication interfaces 906, and an I/O interface 908, each of which may be communicatively linked by a communication link 910 that may take the form a system bus and/or some other connection mechanism. Each of these components may take various forms.

For instance, the one or more processors 902 of the example client device 900 may comprise one or more processor components, such as one or more CPUs, GPUs, NPUs, ASICs, DSPs, and/or programmable logic devices such as FPGAs, among other possible types of processing components.

In turn, the data storage 904 of the example client device 900 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 9, the data storage 904 may be capable of storing both (i) program instructions that are executable by the one or more processors 902 of the example client device 900 such that the example client device 900 is configured to perform any of the various functions disclosed herein (including but not limited to any of the client-side functions discussed above), and (ii) data that may be received, derived, or otherwise stored by the example client device 900.

The one or more communication interfaces 906 may comprise one or more interfaces that facilitate communication between the example client device 900 and other systems or devices, where each such interface may be wired and/or wireless and may communicate according to any of various communication protocols. As examples, the one or more communication interfaces 906 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 908 may generally take the form of (i) one or more input interfaces that are configured to receive and/or capture information at the example client device 900 and (ii) one or more output interfaces that are configured to output information from the example client device 900 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 908 may include or provide connectivity to output components such as a display screen and/or an audio speaker, among other possibilities.

It should be understood that the example client device 900 is one example of a client device that may be used with the examples described herein. Numerous other arrangements are possible and contemplated herein. For instance, in other examples, the example client device 900 may include additional components not pictured and/or more or fewer of the pictured components.

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

We claim:

1. A computing platform comprising:
at least one processor;
at least one non-transitory computer-readable medium; and
program instructions stored on the at least one non-transitory computer-readable medium that, when executed by the at least one processor, cause the computing platform to:
generate a first prompt for input to one or more generative AI models, wherein the first prompt comprises construction-based input data and a request to determine a type of construction activity log to be generated;
input the first prompt to the one or more generative AI models thereby causing the one or more generative AI models to output an indication of a type of construction activity log to be generated;
based on the indication of the type of construction activity log to be generated, obtain a template for the type of construction activity log to be generated;
generate a second prompt for input to the one or more generative AI models, wherein the second prompt comprises the template for the type of construction activity log to be generated, the construction-based input data, and a request to generate a construction activity log of the indicated type;
input the second prompt to the one or more generative AI model thereby causing the one or more generative AI models to generate a construction activity log of the indicated type; and
cause a client device associated with a user to present a representation of the generated construction activity log.

2. The computing platform of claim 1, wherein the one or more generative AI models comprise a single generative AI model.

3. The computing platform of claim 1, wherein the one or more generative AI models comprise a first generative AI model and a second generative AI model,
wherein the program instructions that, when executed by the at least one processor, cause the computing platform to input the first prompt to the one or more generative AI models comprise program instructions that, when executed by the at least one processor, cause the computing platform to input the first prompt to the first generative AI model thereby causing the first generative AI model to output the indication of the type of construction activity log to be generated, and
wherein the program instructions that, when executed by the at least one processor, cause the computing platform to input the second prompt to the one or more generative AI models comprise program instructions that, when executed by the at least one processor, cause the computing platform to input the second prompt to the second generative AI model thereby causing the second generative AI model to generate the construction activity log of the indicated type.

4. The computing platform of claim 3, wherein the second generative AI model is one of a set of type-based generative AI models, each corresponding to a respective type of construction activity log, the computing platform further comprising program instructions stored on the at least one non-transitory computer-readable medium that, when executed by the at least one processor, cause the computing platform to:
determine that the indication of the type of construction activity log to be generated matches the type of construction activity log corresponding to the second generative AI model; and
based on determining that the indication of the type of construction activity log to be generated matches the type of construction activity log corresponding to the second generative AI model, select the second generative AI model from the set of type-based generative AI models.

5. The computing platform of claim 1, wherein the program instructions that, when executed by the at least one processor, further cause the computing platform to:
after causing the client device associated with the user to present the representation of the generated construction activity log, receive data indicating one or more interactions of the user with the generated construction activity log;
input the data indicating the interactions of the user with the generated construction activity log to a reinforcement model thereby causing the reinforcement model to generate a score value based for the generated construction activity log; and
retrain the one or more generative AI models based on the score value.

6. The computing platform of claim 1, wherein the template for the type of construction activity log comprises a plurality of input fields, and wherein causing the one or more generative AI models to generate a construction activity log of the indicated type comprises causing the one or more generative AI models to (i) generate a construction activity log comprising the plurality of input fields and (ii) automatically populate the plurality of input fields with construction activity summary data.

7. The computing platform of claim 1, wherein the construction-based input data comprises one or more of image data or video data.

8. The computing platform of claim 1, wherein the one or more generative AI models comprises at least one transformer-based generative AI model.

9. The computing platform of claim 8, wherein the at least one transformer-based generative AI model comprises a large language model (LLM).

10. A non-transitory computer-readable medium having stored thereon program instructions that, when executed by at least one processor, cause a computing platform to:
generate a first prompt for input to one or more generative AI models, wherein the first prompt comprises construction-based input data and a request to determine a type of construction activity log to be generated;
input the first prompt to the one or more generative AI models thereby causing the one or more generative AI models to output an indication of a type of construction activity log to be generated;
based on the indication of the type of construction activity log to be generated, obtain a template for the type of construction activity log to be generated;
generate a second prompt for input to the one or more generative AI models, wherein the second prompt comprises the template for the type of construction activity log to be generated, the construction-based input data, and a request to generate a construction activity log of the indicated type;
input the second prompt to the one or more generative AI model thereby causing the one or more generative AI models to generate a construction activity log of the indicated type; and
cause a client device associated with a user to present a representation of the generated construction activity log.

11. The non-transitory computer-readable medium of claim 10, wherein the one or more generative AI models comprise a single generative AI model.

12. The non-transitory computer-readable medium of claim 10, wherein the one or more generative AI models comprise a first generative AI model and a second generative AI model,
wherein the program instructions that, when executed by the at least one processor, cause the computing platform to input the first prompt to the one or more generative AI models comprise program instructions that, when executed by the at least one processor, cause the computing platform to input the first prompt to the first generative AI model thereby causing the first generative AI model to output the indication of the type of construction activity log to be generated, and
wherein the program instructions that, when executed by the at least one processor, cause the computing platform to input the second prompt to the one or more generative AI models comprise program instructions that, when executed by the at least one processor, cause the computing platform to input the second prompt to the second generative AI model thereby causing the second generative AI model to generate the construction activity log of the indicated type.

13. The non-transitory computer-readable medium of claim 12, wherein the second generative AI model is one of a set of type-based generative AI models, each corresponding to a respective type of construction activity log, and
wherein the non-transitory computer-readable medium also has stored thereon program instructions that, when executed by at least one processor, cause the computing platform to:
determine that the indication of the type of construction activity log to be generated matches the type of construction activity log corresponding to the second generative AI model; and
based on determining that the indication of the type of construction activity log to be generated matches the type of construction activity log corresponding to the second generative AI model, select the second generative AI model from the set of type-based generative AI models.

14. The non-transitory computer-readable medium of claim 10, wherein the non-transitory computer-readable medium also has stored thereon program instructions that, when executed by at least one processor, cause the computing platform to:
after causing the client device associated with the user to present the representation of the generated construction activity log, receive data indicating one or more interactions of the user with the generated construction activity log;
input the data indicating the interactions of the user with the generated construction activity log to a reinforcement model thereby causing the reinforcement model to generate a score value based for the generated construction activity log; and
retrain the one or more generative AI models based on the score value.

15. The non-transitory computer-readable medium of claim 10, wherein the template for the type of construction activity log comprises a plurality of input fields, and wherein causing the one or more generative AI models to generate a construction activity log of the indicated type comprises causing the one or more generative AI models to (i) generate a construction activity log comprising the plurality of input fields and (ii) automatically populate the plurality of input fields with construction activity summary data.

16. A method implemented by a computing platform, the method comprising:
generating a first prompt for input to one or more generative AI models, wherein the first prompt comprises construction-based input data and a request to determine a type of construction activity log to be generated;
inputting the first prompt to the one or more generative AI models thereby causing the one or more generative AI models to output an indication of a type of construction activity log to be generated;
based on the indication of the type of construction activity log to be generated, obtaining a template for the type of construction activity log to be generated;
generating a second prompt for input to the one or more generative AI models, wherein the second prompt comprises the template for the type of construction activity log to be generated, the construction-based input data, and a request to generate a construction activity log of the indicated type;
inputting the second prompt to the one or more generative AI model thereby causing the one or more generative AI models to generate a construction activity log of the indicated type; and
causing a client device associated with a user to present a representation of the generated construction activity log.

17. The method of claim 16, wherein the one or more generative AI models comprise a single generative AI model.

18. The method of claim 16, wherein the one or more generative AI models comprise a first generative AI model and a second generative AI model,
wherein inputting the first prompt to the one or more generative AI models comprises inputting the first prompt to the first generative AI model thereby causing the first generative AI model to output the indication of the type of construction activity log to be generated,
the method further comprising inputting the second prompt to the second generative AI model thereby causing the second generative AI model to generate the construction activity log of the indicated type.

19. The method of claim 18, wherein the second generative AI model is one of a set of type-based generative AI models, each corresponding to a respective type of construction activity log, the method further comprising:
determining that the indication of the type of construction activity log to be generated matches the type of construction activity log corresponding to the second generative AI model; and
based on determining that the indication of the type of construction activity log to be generated matches the type of construction activity log corresponding to the second generative AI model, selecting the second generative AI model from the set of type-based generative AI models.

20. The method of claim 16, further comprising:
after causing the client device associated with the user to present the representation of the generated construction activity log, receiving data indicating one or more interactions of the user with the generated construction activity log;
inputting the data indicating the interactions of the user with the generated construction activity log to a reinforcement model thereby causing the reinforcement model to generate a score value based for the generated construction activity log; and
retraining the one or more generative AI models based on the score value.
